(19) United States
(12) Patent Application Publication
(10) Pub. No.: US 2014/0279034 A1
(43) Pub. Date: Sep. 18, 2014

(54) PRODUCTS, SYSTEMS, AND METHODS FOR CREATING AND INTERACTING WITH A MOBILE COMMUNITY

(71) Applicant: Avabar, LLC, Minnetonka, MN (US)

(72) Inventor: Koshy Samuel, Minnetonka, MN (US)

(73) Assignee: Avabar, LLC, Minnetonka, MN (US)

(21) Appl. No.: 14/215,900

(22) Filed: Mar. 17, 2014

Related U.S. Application Data
(60) Provisional application No. 61/792,097, filed on Mar. 15, 2013.

(51) Int. Cl. H04L 29/08; G06Q 30/02; G06Q 50/00

(52) U.S. Cl. CPC H04L 67/22; G06Q 50/01; G06Q 30/0267
USPC 705/14.64; 709/224

(57) ABSTRACT

The present disclosure is directed to methods and systems for users to engage with a mobile community. The system includes a mobile device configured to send and receive communication, and a mobile community provider that is communicatively coupled to the mobile device via a network, wherein the mobile community provider includes a user activity analyzer engine and a relationship analyzer engine.

### CROSS-REFERENCE TO RELATED APPLICATIONS

This application claims priority to App. Ser. No. 61/792,097, entitled “Products, Systems, and Methods for Creating and Interacting with a Mobile Community,” filed Mar. 15, 2013, the entire contents of which are hereby incorporated by reference, including all appendices.

### FIELD OF THE INVENTION

The present disclosure generally relates to products, systems, and methods for enhancing, improving, and expanding a user's social media experience and options.

### BACKGROUND

Mobile social networking may generally be described as social networking where individuals with similar interests connect and share with one another through their mobile phone and/or tablet. Much like web-based social networking, mobile social networking occurs in virtual communities. A current trend for social networking websites is to create mobile applications to give their users instant and real-time access from their device. The line between mobile and web-based social networking is being blurred as mobile applications use existing social networks to create mobile applications. Mobile and web-based social networking systems often work together to spread content, increase accessibility and connect users from wherever they are.

Social networking generally includes several loose categories of technology, including for example: texting applications (including group texting) that allow people to send short messages to update others in real time about their current status, for example; radar-type or geo-tagging applications that may alert a user when a person in their contact list, for example, is located near the user; dating services that generally allow a user to post a profile and search other profiles with the goal of talking to or setting up a date with a person of interest; and general social networking sites that allow users to post images, text, profiles, etc. that any user of the site may view and respond to, or alternately only a select population may view. Despite these known technologies there is not a current product that is specifically tailored to the mobile, technologically savvy, twenty- to thirty-something crowd that combines all of these functions and more. Accordingly, there is a need for an application and product that provides a user with a convenient “one-stop” social media shop that can be taken on the go, that is updated in real time, and that may provide the type of information a user seeks that is specifically tailored for a specific user that is packaged in a user-friendly, accessible manner.

### BRIEF SUMMARY OF THE INVENTION

The present disclosure is directed to methods and systems for users to engage with a mobile community. The system includes a mobile device configured to send and receive communication, and a mobile community provider that is communicatively coupled to the mobile device via a network, wherein the mobile community provider includes a user activity analyzer engine and a relationship analyzer engine.

### DESCRIPTION OF THE DRAWINGS

FIG. 1 shows a schematic of an embodiment of a system of the present disclosure.

FIG. 2 shows components of a user fit engine according to some embodiments of the present disclosure.

FIG. 3 is a schematic showing some features of the mobile community provider, according to embodiments of the present disclosure.

FIG. 4 is a screen shot for a log in page, in accordance with embodiments of the present disclosure.

FIG. 5 is a screenshot of a user interface dashboard according to some embodiments of the present disclosure.

FIG. 6 is a heat map interface for use with some embodiments of the present disclosure.

FIGS. 7A-7B are applications that may be used with the heat map interface according to some embodiments of the present disclosure.

FIG. 8 is a screen shot of a smartphone displaying a user interface for the heat map according to some embodiments of the present disclosure.

FIG. 9 is a screen shot of a smartphone displaying a user interface for the scan artist function according to some embodiments of the present disclosure.

FIG. 10 depicts a computer-implemented system suitable for use with embodiments of the present disclosure.

FIGS. 11A-11B depict screen shots for an online interface, in accordance with embodiments of the present disclosure.

FIGS. 12A-12B depict screen shots for vendor and venue sign up forms for an online interface, in accordance with embodiments of the present disclosure.

FIG. 13 is a screen shot for a log in page, in accordance with embodiments of the present disclosure.

FIGS. 14A-14N are screen shots for a venue online interface, in accordance with embodiments of the present disclosure.

FIGS. 15A-15I are screen shots from one embodiment for the venue online interface.

FIGS. 16A-16T are screen shots for a vendor online interface, in accordance with embodiments of the present disclosure.

FIGS. 17A-17S are screen shots from one embodiment for the vendor online interface of FIGS. 16A-16T.

FIGS. 18A-18C are screen shots for a “super vendor” online interface, in accordance with embodiments of the present disclosure.

FIGS. 19A-19O are screen shots for an administrator online interface, in accordance with embodiments of the present disclosure.

FIGS. 20A-20L are screen shots from one embodiment for the vendor online interface of FIGS. 19A-19O.

FIGS. 21-24 show screen shots from an embodiment of a user interface. FIGS. 21A-21G relate to one method for logging into the user's account, creating a new account, or viewing the user's profile. FIGS. 22A-22P show various features of an embodiment of the user home screen. FIGS. 23A-23K show various features related to editing the user's profile and settings. FIGS. 24A-24G show various features related to the musing feature and rewards features of the present disclosure.

### DETAILED DESCRIPTION

The present disclosure is generally directed to an on-line and smartphone (or tablet) driven application for accessing and interacting with a community of user/members. In one embodiment, the products, systems, and methods of the present disclosure are directed to the 21-34 year old demographic. For many people in this age bracket, a large proportion of available entertainment time and money is spent on technology, particularly social media applications and hardware related thereto (smartphones, laptops, tablets, etc.), and socializing with peers at restaurants, bars, and nightclubs. Accordingly, some embodiments of the present disclosure are directed to products, systems, and methods for mobile smartphone driven applications that include content, features, and modules that are specifically geared toward the interests of the 20- to 30-something crowd. In still other embodiments, the products, systems, and methods of the present disclosure may be directed toward any suitable and appropriate age group. More particularly, in some embodiments the present disclosure is directed toward a smartphone accessible web-based application that caters to the specific interests and real time location of a particular member that may be “out on the town” already, or that may be deciding where to go, or where to go next, including for example, to a bar, club, or restaurant.

In one embodiment, the user-side functionality of the invention of the present disclosure may be accessed and engaged with via a smartphone. In some embodiments of the present disclosure, the invention may include tools or features that may allow a user to, for example, but not limited to: manage social media presence in a unique way; interact with both general and targeted user groups with highly engaging tools; identify niche-specific “trending”; query and engage other users in a unique way; offer and or accept drink specials, or other specials or deals; and engage in e-commerce tailored to the interests or location of the user.

FIG. 1 illustrates a diagram of a Mobile Community System (MCS) (or just “system”) 100 according to some embodiments of the present disclosure. One or more users, for example a user at user device 120 may be coupled to the Mobile Community Provider (MCP) 140 via a network 160. The user device 120 may be a smartphone in some embodiments. The smartphone may include a processor for implementing logic, a memory, a display and a keypad. The smartphone may have the ability to take, send, and/or receive photos; send and receive texts; have GPS capabilities; have access to the Internet, and/or many other functionalities. In some cases, the user device may be, or may also be a laptop, desktop, tablet, or any other suitable device. The network may operate in a cloud-based environment or SAAS platform to allow for scalability, in some embodiments. In some embodiments, the network 160 may be any network including local area networks, wide area networks, wireless networks, or any other suitable network. The network 160 may be enabled to use any form of computer readable media for communicating information from one electronic device to another. The network 160 may include the Internet in addition to local area networks, wide area networks, direct connections, such as a universal serial bus port, other forms of computer-readable information, or any combination thereof. The one or more user devices 120 may also be coupled to one or more social networking sites via a network.

In some cases, the member or user may be an individual. In other cases, the member may be a business or other vendor. For example, a member may be a restaurant, nightclub, bar, or store for example. The user interface for a business or venue member may be generally the same as that for individual members or it may be different and specifically tailored for use by businesses. For example, a particular bar or venue may be a member (referred to herein generally as a “venue member”) and may have a business member page that may be generally similar to that of an individual member, but additional applications or features may also allow the business to provide the MCP 140 with various specials, targeted specials, promotions or advertising that the MCP 140 may send to targeted individual members, for example. In some embodiments a member may be a distributor, for example a liquor distributor, supplier, manufacturer, or retailer (referred to herein generally as “distributor member”). In such cases, the distributor member may make certain specials available on certain types or brands of alcohol that a venue member, such as a bar, may wish to make available to other individual members. The distributor member may also have its own member page with specific functionality directed to applications suited to the distributor member. In some cases, for example, the distributor member may make specials available to venue members via the system. In other cases the MCP 140 may be the intermediary between the distributor member and the venue member.

A User Fit Engine 180 may be coupled to the MCP 140. The User Fit Engine 180 stores and in some cases analyzes data, such as a member's profile data, current location, likes and dislikes, member contacts, etc. The User Fit Engine 180 may be in communication with any other portion of the system 100 and may include one, two, or many databases including one or more programs for analyzing data. The User Fit Engine 180 may include data on any type of member, including an individual member, venue member, vendor member, or distributor member. In some embodiments, the User Fit Engine 180 may allow the MCP 140 to provide the member with member specific relevant information that in some cases may be updated and pushed to the member in real time in response to unfolding events, (e.g. the member entering a certain nightclub may trigger the User Fit Engine 180 via the MCP 140 to send the member a targeted drink special based on user-dictated preferences, for example, that the member may use at that night club). The User Fit Engine 180 may also provide a user with an analysis of other members that may be nearby, for example, whereby the analysis includes a match or a matching score based upon an analysis of the two members' profiles, for example, via the relationship analyzer component 208. Accordingly, as may be seen in FIG. 2, the User Fit Engine 180 may include one or more components for handling such analyses, including, but not limited to a user activity analyzer component 204, and/or a relationship analyzer component 208.

FIG. 3 provides a diagram of a Mobile Community Provider 140 according to some embodiments of the present disclosure, such as the MCP 140 discussed with reference to FIG. 1. A profile database 310 may be provided for storing (or securely storing) data associated with each of the members of the Mobile Community (MC). When a user initiates a subscription with the MCP 140, a user may set up a profile. The profile may include privacy settings, contact information, information about the member, including possibly information ported from other social media sites, a user's likes and dislikes related to almost anything, and/or any other information that may be useful or desired may be included in the collection of data at the time the profile is set up, with the resulting data being saved in the profile database 310. In some embodiments, when a user, for example an individual user first registers with the System 100, the user may be prompted for information. In some embodiments, some or all of the requested information may be required for membership in the System 100. Individual members, for example, may be asked to provide some or all of the following, some or all of which may be “required information” in some cases: selecting their body type based on one or more options; their favorite type of music; their occupation; their “celebrity doppelganger”; one or more adjectives that describe them; their top drink preferences. In some cases more or less information may be sought. The user may be asked to choose among one or more options provided, in some cases, while in other cases, the user may be permitted to provide a “free-foam” response, or some combination thereof. The information stored in the profile database may be updated, changed, deleted, for example, as needed or as desired by the member and/or the MCP 140. The profile database 310 may also include relationship data used by or obtained from the relationship analyzer component of the User Fit Engine (shown in FIG. 2) that monitors, and/or detects and stores, for example, a members' interactions with other members (where the member could be a business or an individual, for example). Various meta-data may be associated with the data stored in the profile database, including, for example, but not limited to various permissions for access. Some sharing rules, or access permissions may be selected based on, or at least in part on an input provided by the member, while other access permissions may be default permissions or denials that are based on other constraints, events, rules, etc. that may be initiated by the MCP.

The profile interface 320 may be the mechanism by which a member interacts with the mobile community (for example other members in the mobile community) and the MCP. The profile interface 320 may be an online user interface for use with laptops or desktops for example, or it may be a smartphone interface for use with a smartphone.

The MCP may also include one or more various modules such as but not limited to a heat map module 322, a musing module 324, a scan artist module 326, and/or an intel module 328. Any of the modules may make use of the User Fit Engine 180 of the MCP, including, but not limited to the user activity analyzer component and the relationship analyzer component. The heat map module 322 may use GPS mapping that may identify locations that are trending with respect to volume of guests and activity, and/or identify locations where people of user-specified interest are congregating, for example; the musing module 324 may provide a search function for querying a % match to one or more other users for different criteria; the scan artist module 326 may include features that may leverage the camera feature of a smart phone to scan a location for other users that may be identified by an icon that may be clicked-on for information about the other users/venues; and the intel module 328 may provide specific relevant information regarding locations, users, drink, dinner, or cover-charge specials of interest to the user, based on for example interests of the user and/or the location of the user.

The profile interface, as explained above, may include one or more interfaces that may be accessed and used depending on the authentication level of a member (for example an individual versus a business) or based on the type of device that is being used (for example a smartphone or a laptop). The online user interface may be specifically configured for use on a laptop, desktop, or tablet, for example, that typically have larger screens than smartphones, while the smartphone user interface may be configured for use with a smartphone. A user may access the Mobile Community site in a known manner, i.e. by typing the URL for the site into a browser; by clicking on a saved favorites link to the site on a search engine page; or by searching for the site on a search engine site, for example. Some features of the site may be accessible to the public. For example, a promotional page, sign-up page, news page, etc. may be viewed by anybody accessing the site, in some embodiments. In other embodiments, however, the site may provide no information to the general public other than possibly information related to becoming a member, and may only provide information, content, and functionality to members. FIG. 4 shows a log-in screen for the site according to one embodiment where no information is accessible to the public. In this embodiment, a user must provide a password 402 before being able to access any of the features of the site. The Mobile Community of the present disclosure may include only members of the site, in some embodiments. In other embodiments, the mobile community may be broader, including for example, contacts and/or friends (that may not be members of the site) that may be input into the system by a member of the site. Still other community inclusion and exclusion criteria are possible and are within the scope of the present disclosure. Some or all of the site may be password protected, or otherwise configured to allow secure access to a user.

The profile interface may include a profile set-up application that may help direct a user through the initial account creation and/or profile creation. In some cases, the profile set-up application may be configured to port information from other sites the user may belong to and for which the user may have already created a profile. In some embodiments, the MCP may automatically configure any data ported in to be compatible with the design and style of the present site. The user's approval for some and/or all of the ported data may be required before the present site stores, uses, and/or displays data ported from other sites. Ported data could be from any suitable or desired location, such as an online dating site, a general social networking site, a career oriented networking site, or any other location.

Once a user's log in information has been authenticated and validated, the member may be directed to a unique member homepage. In some embodiments, the homepage may be a user-friendly dashboard that may be used to manage some or all of the member's social media activities. FIG. 5 provides a user interface dashboard according to one embodiment of the present disclosure. In some embodiments, the home dashboard may provide a single unified hub for managing all or some social media activities. The dashboard 502 may include a profile management tool 504 that manages all social media activities, for example, pictures, contacts, or communications. In some cases, features may be included to allow a member to turn on/off what other members or classes of members can see. A dedicated area for a scrolling feed 506 may also be provided. In this area a member may provide the community with their updates or status. A dedicated “places” area 508 and feature may also be included on the dashboard 502. The places area 508 may include places the user has been recently, plans to go to, and trending locations, for example. This feature may also include the ability for the MCP to notify business members of the fact and/or frequency of visits a user makes to its business location, thereby allowing the business to further its marketing goals. For example, a member business that learns of individual members via the MCP that have visited its business, may request the MCP to push a coupon, discount, or other promotional offer to the visiting member. Though other marketing and promotional goals may also be achieved through the use of this feature and are within the spirit and scope of the present disclosure. The dashboard 502 may also include a musing area 510 that may be at least partially driven by the musing module of the MCP. The musing area 510 may provide/display scrolling search results based upon user-specified search parameters, in one embodiment. In another embodiment, the musing area 510 may provide results based on the results of the analysis engines of the MCP for the particular member. In still other embodiments, the musing area 510 may be some combination of both. In some embodiments, the musing feature may use responses provided by a user to determine a match or a match percent. For example, the musing feature may use the body type, music preferences, occupation, celebrity doppelganger, or any other aspect of a user's profile, or combination of aspects to determine a match or a match percent. As may be seen in FIG. 5, the musings area 510 in some embodiments may include photos of people, that may be other members, or contacts, for example, or may be pictures of places or things. The member may hover over a picture and wait for a “bubble” to pop up that provides the member with relevant information or intel about the person, place, or thing in the photograph.

In some embodiments for example, an individual user may go to the musings feature to request and/or search for a match. Via the musings interface, the user may select or provide one or more aspects that describe themselves and/or their ideal match. For example, the user may: provide a description of their own body type, and/or the body type they would prefer in a match; indicate a celebrity they find attractive or that they have a crush on; and provide one or more adjectives that describe their ideal mate, for example. In some cases, the user will be asked to provide more, less, or different information about themselves and/or their ideal match. Based on this information, the musings interface may provide the user with one or more recommendations for matches among MC users, or may provide a percentage match based on a particularly selected user, for example.

The dashboard may include tabs to a heat map interface that provides information retrieved from the heat map module. As may be seen in FIG. 6, a heat map interface 600 may be provided and accessed from the user interface. The heat map interface 600 may include several areas. For example, a degree chart area 604 may be provided that lists places the user frequents and/or places that are trending along with the number of the user's contacts at such places, second degree contacts (friends of friends), and third degree contacts (friends of friends of friends), in some embodiments. The interface 600 may also include an intel area 608 that may provide additional information about a venue, for example. A musing area 620 may also be included on the interface 600 that may provide information such as contacts, first degree, or second degree that are at, or were recently at a venue, for example. In other embodiments, the musing function may provide information about other members that may be a potential match for the user based on the results of the relationship analyzer component, or the user defined search criteria.

In some embodiments, the System may include an “ice breakers” feature, that may be used by a member that wishes to reach out to another member but may be uncomfortable doing so directly in person. As such, a first member may send a second member an ice-breaker, which may be a short statement, observation, question, etc. The first member may create their own ice-breaker in some embodiments, or may select from one or more provided by or suggested by the System. In some embodiments, the number of ice breakers, the character limit permitted for ice breakers, or the time limit available to participate in ice breakers may be a predetermined amount of time in order to incentivize members to speak directly in person. The System may include stock responses to ice breakers also, including for example, polite “thank you, but no thank you,” or any other suitable response. In some embodiments the ice breaker function may be participated in through an instant messaging type of application.

A sunglasses feature may be accessible to one or more parts of the System 100. The sunglasses feature may allow a user to “go off the grid,” such that other users may not be able to view information about them, or in other cases, may only be able to view selected information. In some embodiments, enabling the sunglasses feature may still allow the user to be accessible to one or more features of the System 100. For example, in one embodiment, a user may “put on their sunglasses,” thereby preventing other users from “seeing” them on the System 100, but the user may still be able to receive drink specials at nearby or favorite venues, for example. In some embodiments, the user may be permitted to select the features they wish to turn on and off, while in other embodiments, only a pre-determined feature or set of features may be activated or deactivated by the user.

In some embodiments, the heat map module and/or interface may include functionalities that take advantage of existing applications, such as known GPS locators that provide map views of various locations. For example, as may be seen in FIGS. 7a and 7b, if a MC member performs a search for a business and the business is an MC member, the location may appear with an MC designated icon 720, which the user may click on to see location intel, for example. Further, the heat map module may be used for member businesses to specifically target searching users with specials 810, as may be seen for example in FIG. 8. A heat map smartphone interface 800 may also include an identifier 820, for example on a map, that indicates a location is trending in the number of individual MC members at an MC member business. If a user touches the identifier 820, the intel 850 for the venue may be displayed, including for example venue-specific specials. Further, the musing function area 840 may also be included that may show results for MC members meeting MCP search criteria and/or user-defined search criteria. Still other embodiments may include more or fewer functional areas on a heat map user interface.

In some embodiments, a user may wish to see all users of the System 100 that are in their vicinity. The user may use the heat map feature, or a portion thereof, to do this. The user may decide how to define “vicinity.” In some cases, the user may select an area on a map by zooming in or out on the map, to determine the “vicinity” of interest. In other embodiments, the user interface may prompt the user for a radius of interest, for example, or a zip code. The MC System may display the results of the query in any suitable manner. For example, in response to a query from a user asking how many individual System members are within a 20 mile radius of the user's current location, the MC system may provide a numeric response of “678,” for example. In other embodiments, a map may be provided to the user. The map may provide icons and/or text showing the number of MC users nearby. In some embodiments, a user may be able to tap on or otherwise highlight or select a particular user (“selected user”) on the map. The selected user's profile and/or characteristics and/or the selected user's pre-determined and authorized information may become viewable to the user once selected by the user, unless the selected user has their sunglasses on, for example.

In some embodiments, the map may or may also provide one or more icons for one or more types of venues. The venues may be member or non-member venues and/or may have different icons to indicate same. If a user selects a venue on the map, detailed information about the venue may be provided. For example, information may include how many individual members are currently at the venue, cover charge information, whether the venue has hit maximum capacity or not, amount of time to expect waiting in line to get into the venue, entertainment information, drink and/or dining specials, user rating, user comments, etc.

In some embodiments, the heat map generated may provide icons for venues where the icons are indicative of the relative number of people and/or individual members within the venue. For example, a map may be provided with circles indicating venues. The more people currently in the venue, the larger the circle icon appears on the map, relative to other venues with less people. In some embodiments the size of the icon may be simply proportional, i.e. strictly based on the number of people in a venue, while in other embodiments, the maximum capacity of a venue may be taken into account, and thus the size of the circle may be related to the percentage of the maximum capacity for the venue that has currently been reached.

In some embodiments, a user may select among one or more different information types about the venue from the member user interface. For example, a user may wish to see general venue information as provided above. Additionally, the user may wish to access information related to the general profile of the population currently at a venue. Accordingly, the MC System may provide a user with demographic information about the types of members that are currently at a venue. As such, a user may determine that while a venue may be busy and full of people, which may be desirable to a given user, the majority of the population currently present is between 21-24 and has a preferred music type of hip-hop, which may not be desirable to the user that might prefer, for example, a mix of people that are generally 30 and older and that prefers blues and jazz music. The user may access the different information types about a particular venue in any suitable way. For example, the information types may be providing by means of a drop down menu, or by segmenting the venue icon on the map into different portions, whereby each section may be individually selected and may be directed toward a different information type, for example. It will be understood that any suitable means of providing a user with different information types about a member (individual, distributor, or venue member) is contemplated and within the scope of the present disclosure.

In some embodiments, a user may “follow” one or more different members or groups or types of members. For example, the user may select an individual member to follow. The user may then receive updates from the System about where that member may be or posts the member may make on the system, for example. A user may access a map that shows where a followed member is currently located, for example. If a selected user has their sunglasses on however, another user may not be able to follow them in this way. In some cases, a setting on the sunglasses feature may allow a user to only block others from following them, but may otherwise allow other member users to access information about them. A user may or may also create a “group to follow” by selecting one or more members to follow. For example, a user may select eight member friends that are all going out in generally the same location on a given night. The user may then have a particular area on the user interface that may easily track the group's location, individual members of the group's location, instant messages, posts to the system, etc. Additionally, a user may create a group of one or more venues that the user may wish to have information about.

The scan artist feature of the MC may also be accessed via the user interface of the smartphone, or alternately, it may appear as an option for logged in MC members that simply attempt to use the camera function on the smartphone. In one embodiment, illustrated in FIG. 9, the user activates the camera function of the smartphone (either directly or through the MC user interface) and scans a venue for other MC members, or scan a street for venue information, for example. Other MC members may be designated by an icon 920 or other means of identification. Other MC members that meet the member's search criteria may be identified differently than other present MC members. For example, present MC members that meet search criteria may be highlighted in a different color 940. It will be understood that any identification method, or combination of identification methods may be used. If the user taps on the icon, an intel bio 960 may be displayed with key information about that member, including in some embodiments, commonalities between the user and the identified member. In some embodiments, a member can select a “detect on” or “detect off” designation. For example, a member may be out at a bar but may not want to have other members be able to identify them as members, in which case that member may select a “detect off” setting.

The MC System may also include a drink specials feature. It will be understood by those skilled in the art, however, that while this feature is described with reference to drink specials, other types of specials are also contemplated, for example food specials, sales of consumer goods and services, etc. The System may allow a distributor member and/or a venue member (the “offering member”) to create one or more drink specials. The offering member may then make the special available to one or more other members. For example, a distributor member may make a drink special available to a venue member that may in turn make the drink special available to one or more individual members. Alternately, or additionally, a distributor member may make a drink special available directly to one or more individual members, or a venue member may make a drink special available to one or more individual members directly. An individual member may access relevant drink specials in one or more ways. In some embodiments, an offering member may “push through” the drink special to the member. The member may then access incoming drink specials from the user interface. The individual member may also search for ongoing drink specials at venues of interest, or by nearby venues offering a particular type of drink special, for example, whiskey drinks, or even more particularly a specific brand of whiskey drink. If the System locates a venue within a predetermined vicinity that offers that particular drink special, the System may also provide the user with walking and driving directions to the venue from the user's location or other location, as desired. In some embodiments, the drink specials made available to a member, may be made in real-time, so as a venue member or distributor member makes a drink special available, it may automatically and generally instantly be made available to a selected user, for example.

In some embodiments the drink special may simply be informative text, directing the user member to the venue offering the special, whereby the special is available to all consumers in the venue that evening, for example. In other cases, however, the drink special may only be made available to a select number of members, or even a single member. In that case, the drink special itself as seen on the user's mobile device may become a voucher that needs to be redeemed at the venue. In some embodiments, the voucher may have a barcode that may be scanned at the venue for redemption. In other embodiments, the voucher may include animation, such that it may not be readily duplicated and sent to other members that were not intended recipients of the voucher. Any other suitable means of providing a user with a voucher are also contemplated and within the scope of the present disclosure.

An offering member may use the System to specifically target a particular sub-set of individual members for particular specials. For example, the offering member may use a feature on the offering member's user interface that permits the offering member to search the system for members in one or more categories. For example, the offering member could search for all of the members in a particular age bracket, in a particular vicinity, that prefer a particular type and/or brand of alcohol, for example. In another example, a vendor offering member may determine that there are too few females in the venue at a particular time. The vendor may therefore search for all female members in a particular vicinity in a particular age range. Once the offering member has performed a search to its satisfaction or otherwise selected one or more members to send the drink special to, the offering member may use the System to send the drink offer to those members. In some embodiments, the System may tell the offering member how many members the search found. If the number is too great, the offering member may wish to narrow the search criteria further before sending the drink offer. If the number of hits is too small, the offering member may wish to broaden the search criteria before sending the drink offer.

Additionally, in some embodiments, a point-of-sale feature may also be included in the System. For example, an individual member may wish to purchase a drink for another member via the System. The System may include connectivity with Paypal or another user payment system, for example. Or in other cases, the System itself may include a “bank account” feature, whereby a member can deposit funds securely into the System that may later be used to pay for items through the System. As such, a user member that wishes to buy a drink (including tip, if desired) for another user member may do so entirely on the System. The System may then send a message to the user recipient notifying them that the purchasing user has bought them a drink. The message may also include an appropriate drink voucher that may be used at that particular venue. The recipient user may then show the bartender the voucher to obtain the drink.

The System may also include a loyalty rewards program, in some embodiments. For example, if a member uses a certain number of drink specials via the System, the user may be sent a redeemable drink coupon for the user's favorite drink. The loyalty rewards system may be tied to a particular venue, or a particular type of drink, for example. The user may be rewarded with points that may be redeemable for prizes, or may be rewarded with vouchers. The rewards may be limited in time, such that a member only has a limited amount of time to redeem a voucher, for example. The loyalty reward system may include any other suitable mechanism for rewarding a member user for using the system. In some embodiments, a distributor vendor for example, may wish to reward a user for drinking a particular brand of alcohol for example. If a member takes advantage of a certain number of drink specials including that type of alcohol, for example, the distributor member may reward the member with a rebate ticket that may be used to purchase that type of alcohol at a retailer, for example. State and federal laws involving vouchers, rebates, etc. and alcohol may be incorporated into the System, such that only legally valid rewards are offered to a member in a particular state.

In some embodiments, the System may include or may also include an Analytics Report that may be requested and/or provided to one or more members. The Analytics Report may include data that is captured in the System that a user may wish to see. The data, in some cases, may be stripped of identifiers, such that individual members may not be identifiable, but rather only aggregate data may be made available in Reports. Such reports may be useful and beneficial to a number of members for a number of purposes. For example, the Report may be useful for member businesses to enable them to conduct target advertising. The member business may request a Report that shows what age group, gender, and time of year the most mai tai's, for example, are purchased. Based on the report, the member business may offer drink specials to members fitting the analytics provided in the Report at the designated time of the year. In some cases, a Report may be provided to a member at certain specified time periods, for example weekly, monthly, yearly, or any other suitable time period. For member business, the Report may include valuable “end-to-end” member consumer information. For example, how many drink specials offered were viewed, what percentage of redeemed drink specials were from members, what were the demographics of the members that redeemed the special v. the demographics of those that viewed the special but did not redeem it, etc. The analytics feature may further include the ability to take one type of information, for example, the end-to-end consumer buying data and cross-link it with another type of data, for example, demographic data in order to allow for behavioral and predictive modeling, which may be highly valuable for businesses, for example.

A Report may also be of value to individual members. For example, a Match Report may be provided that tracks the demographics of the types of people that are interested in the member, whether those characteristics match the characteristics the member says they would like to be present in their ideal mate, the types of venues that have the largest population of people they are interest in, or people that are interested in them, etc. The Report may also provide recommendations for the member, such as suggesting different venues, times or days to go to those venues, etc.

While embodiments of the present disclosure have been described with regard to a social media application for the 20- to 30-something demographic, it will be understood that other environments targeted to different groups are also possible. For example, a business community application is also possible. Such an application may involve a member providing business related information as opposed to largely personal information, whereby service providers may indicate for example what services they offer, reviews from former clients, etc., and whereby members may also provide information to the system regarding any service or other business needs they may have, such that the system could match individuals that may benefit from meeting (i.e. a person looking for a professional to complete granite installation may use the scan artist feature at a restaurant or anywhere else to see if such a person is in the vicinity, and if they are may read their reviews and if they are interested in discussing business with the person may send them a communication via the application). Still other embodiments are possible and within the scope of the present disclosure.

Embodiments of the present disclosure may be implemented through one or more computing devices connected with one another through an electronic network. As shown particularly in FIG. 10, a computing device used with the present disclosure, may be part of a larger network system 225 of devices. System 225 may include one or more computing devices 226 connected with a network 250, such as the Internet. Computing device 226 can interact with a server 246 in order to input and receive information.

System 225 may also include the ability to access one or more web site servers 248 in order to obtain content from the Internet for use with the social media-based systems and methods described herein. While only one computing device is shown for illustrative purposes, system 225 may include a plurality of computing devices 226 and may be scalable to add or remove computing devices to or from a network.

Computing device 226 illustrates components of an embodiment of a suitable computing device for use with the present disclosure. Computing device 226 may include a main memory 230, one or more mass storage devices 240, a processor 242, one or more input devices 244, and one or more output devices 236. Main memory 230 may include random access memory (RAM), read-only memory (ROM), or similar types of memory. One or more programs or applications 280, such as a web browser, and/or other applications may be stored in one or more data storage devices 240. Programs or applications 280 may be loaded in part or in whole into main memory 230 or processor 242 during execution by processor 242. Mass storage device 240 may include, but is not limited to, a hard disk drive, floppy disk drive, CD-ROM drive, smart drive, flash drive, or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250, for example, a network connecting the computing devices to the system of the social media platform. Input interface 203 may include any device for entering information into computing device 226, such as but not limited to, a microphone, digital camera, video recorder or camcorder, keys, keyboard, mouse, cursor-control device, touch-tone telephone or touch-screen, a plurality of input devices, or any combination of input devices. Output device 201 may include any type of device for presenting information to a user, including but not limited to, a computer monitor or flat-screen display, a printer, and speakers or any device for providing information in audio form, such as a telephone, a plurality of output devices, or any combination of output devices.

Applications 280, such as a web browser, may be used to access a social media platform such as Facebook, for example, by connecting the host server of the social media platform. Any commercial or freeware web browser or other application capable of retrieving content from a network and displaying pages or screens may be used. In some embodiments, a customized application 280 may be used to access, display, and update information.

A server 246 may also be connected to the network 250. Server 246 may include a main memory 252, one or more mass storage devices 260, a processor 262, one or more input devices 264, and one or more output devices 256. Main memory 252 may include random access memory (RAM), read-only memory (ROM), or similar types of memory. One or more programs or applications 281, such as a web browser and/or other applications, may be stored in one or more mass storage devices 260. Programs or applications 281 may be loaded in part or in whole into main memory 252 or processor 262 during execution by processor 262. Mass storage device 260 may include, but is not limited to, a hard disk drive, floppy disk drive, CD-ROM drive, smart drive, flash drive or other types of non-volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keys, keyboard, mouse, cursor-control device, touch-tone telephone or touch-screen, a plurality of input devices, or any combination of input devices. Output device 256 may include any type of device for presenting information to a user, including but not limited to, a computer monitor or flat-screen display, a printer, or speakers or any device for providing information in audio form, such as a telephone, a plurality of output devices, or any combination of output devices.

Server 246 may store a database structure in mass storage device 260 for storing user information. Any type of data structure can be used, such as a relational database or an object-oriented database.

Processors 242, 262 may, alone or in combination, execute one or more applications 280, 281 in order to provide some or all of the functions, or portions thereof, of the social media-based system and method described herein.

Importantly, the System 100 not only interacts with individual users, but also shares information and data analytics with vendors and venues, and allows vendors and venues to advertise deals to these users. In some embodiments, a web-based profile interface may be provided, which may be particularly suitable for members such as vendors, venues, and system administrators to access the MCP 140 from a user device 120 having a web browser. Examples of screen shots are provided in FIGS. 11-13. FIG. 11A shows a home screen 1100, which may feature information or advertising material related to venues 1102 or vendors 1104 and FIG. 11B shows a screen 1108 featuring an ad 1110 for one of the venues or vendors. Venues (such as bars, restaurants, and nightclubs) may sign up for the system on a venue sign in page 1200 as shown in FIG. 12A, by providing contact information such as the bar name 1202, address 1204, phone number 1206, website 1208, a description of the venue 1210, photos 1212, e-mail contact information 1214, and hours 1216. The venue may also select e-mail preferences as shown generally at 1218 to determine how often the system will send the venue updates to its users. At least for searching or indexing purposes, the venue may also select the type of activities available at the venue, such as dancing, sports, and live music, as shown generally at 1220, and the venue may also select the type of venue, such as lounge, club, restaurant or bar, as shown generally at 1222. In at least one embodiment, a venue must agree to the system's terms of service shown generally at 1224 and then press the submit button 1226 before the venue will be accepted into the system. Vendors (such as liquor manufacturers) may also sign up for the system on a vendor sign in page 1230 as shown in FIG. 12B, by providing contact information such as the vendor name 1232, contact name 1234, contact e-mail 1236, and phone number 1238. At least for searching or indexing purposes, the vendor may also select its goods or services type, for instance, it may select a particular type of alcohol that it sells (beer, wine, vodka, whiskey, etc.) as shown generally at 1240. In at least one embodiment, a vendor must agree to the system's terms of service shown generally at 1242 and then press the submit button 1244 before the vendor will be accepted into the system.

FIG. 13 shows a log-in screen 1300 for the site according to one embodiment where no information is accessible to the public. In this embodiment, a user (such as an individual, vendor, or venue) must provide a password 1302 before being able to access any of the features of the site or their particular module screen.

FIGS. 14A-14N show a venue interface 1400 that communicates with the MCP 140. The authorized user for the venue may select various features on the venue module screen 1400 to view vendor promotions 1402, events 1404, or data analytics 1406 associated with the venue. The authorized user may also manage the venue account through the management feature at 1408 and may also securely log out from the system through the logout feature at 1410. In some embodiments, such as those shown in these Figures, the promotions feature 1402, events feature 1404, data analytics 1406, management feature 1408 and logout feature 1410 are always visible on venue home screen 1400. FIG. 14A shows the venue interface 1400 with the promotions feature 1402 selected. Promotions feature 1402 may in some embodiments allow the authorized user to view new promotions 1412, as shown in FIG. 14A; to view current promotions 1414, as shown in FIG. 14B; to view upcoming promotions 1416, as shown in FIG. 14C; and to view promotions that the venue has opted out from honoring 1418, as shown in FIG. 14D. Each promotion may be transmitted to the venue from the vendor through system 100. In each instance, a list of relevant promotions 1422, 1424, 1426, 1428 are displayed. Each list may display the vendor, the offer information and the location. Each list may also provide the authorized user with an action item, as shown at 1430, such as to view additional information about the promotion 1432, as shown in FIG. 14E. In at least one embodiment, the information provided may include a banner image 1436 and an additional image or copy 1438. In at least one embodiment, the user may also view the loyalty reward associated with the promotion, as shown at 1434. In FIG. 14F, when the user wishes to view the loyalty reward by selecting 1434, the user device then displays the loyalty reward 1434 for an authorized user of the venue to view.

Events feature 1404 may in some embodiments allow the authorized user to view published events 1440, as shown in FIG. 14G; to view draft events 1442, as shown in FIG. 14H; to create new events 1444, as shown in FIGS. 14I-14J; and to edit events as shown in FIG. 14K. When viewing published or draft events, the events may be displayed in a list form as shown at 1446, 1448. Each list may display the date, title and description of the event. Each list may also provide the authorized user with action items, such as to publish or unpublish 1450, edit 1452, or delete 1454 the event. To create a new event 1444, as shown in FIGS. 14I-14K, an authorized user enters an event title 1456, an event description 1458, a start date and time 1460, an end date and time 1462, and selects either that the event is a one-time event 1464 as shown in FIG. 14I or a recurring event 1468 as shown in FIG. 14J. If the event is a recurring event, the authorized user selects the recurrence parameters 1470 and an end date 1472. In at least one embodiment, a calendar feature 1474 is utilized to help an authorized user select the dates. The authorized user then saves the new event by selecting the save feature 1476. FIG. 14K shows an embodiment where a user is editing a prior published or drafted event. Here, the authorized user can modify the event title 1456, the event description 1458, the start date and time 1460, the end date and time 1462, and whether the event is a one-time event 1464 or a recurring event 1468. The authorized user then saves the new event by selecting the save feature 1476.

FIGS. 14L-14M show the data analytics feature 1406, which allows an authorized user to review analytics reports, which may be regularly occurring reports or custom-created. In at least one embodiment, the reports are displayed in a list form as shown at 1480. The authorized user may be provided with several action items, shown generally at 1482 related to the list, such as to view the report (as shown in FIG. 14M), to delete the report, to download the report, or to share the report. In at least one embodiment, the report may be viewed directly within venue home screen 1400 as shown in FIG. 14M. Data available to venues from analytics reports may include, but are not limited to, number of appearances on individual user's home screens, number of times the venue's location pin is tapped, number of profile views, number of check-ins, number of times each opted in promotion is opened on venue's profile, number of times each opted in promotion is redeemed, number of clicks on the events section of the venue's profile, click paths to venue's profile, number of user swipes to retrieve additional information, number of taps on venue's profile, mean number of check-ins per hour, mean quantity of patrons per hour, and/or mean time spent at venue, all of which can be further reviewed and analyzed based on particular demographic attributions.

FIG. 14N shows the management feature 1408. Here, the authorized user may edit any of the parameters entered for the particular venue on the venue sign in page, including the bar name 1484, address 1485, phone number 1486, website 1487, a description of the venue 1488, photos 1489, e-mail contact information 1490, hours 1491, e-mail preferences 1492, activities 1494, and venue type 1496. The user can then save the changes by selecting the “save” button 1498.

FIGS. 15A-15I show an embodiment 1500 of the venue interface shown in FIGS. 14A-14N. The authorized user for the venue may select various features on the venue module screen 1500, which may include features to view vendor promotions 1502, venue events 1504, or venue data analytics 1506 associated with the venue. The authorized user may also manage the venue account through the management feature at 1508 and may also securely log out from the system through the logout feature at 1510. FIG. 15A shows the venue module screen 1500 with the promotions feature 1502 selected. Promotions feature 1502 may in some embodiments allow the authorized user to view new promotions 1512, to view current promotions 1514, to view upcoming promotions 1516, and to view promotions that the venue has opted out from honoring 1518. Each promotion may be transmitted to the venue from the vendor through System 100. As shown in FIG. 15A, a list 1522 of relevant promotions is displayed, and the user may selectively view new promotions 1512, current promotions 1514, upcoming promotions 1516, and opted out promotions 1518, and combinations thereof as the authorized user by selecting the appropriate feature 1512, 1514, 1516, 1518. In other words, current promotions and upcoming promotions can be viewed simultaneously, for example. Each list may display the vendor 1526, the offer information 1528 and the duration of the offer 1529. Each list may also provide the authorized user with an action item, as shown at 1530, such as to opt in or opt out. In at least one embodiment, the authorized user can view the promotion by selecting the item from the list 1522. FIG. 15B shows a selected promotion 1532, which displays relevant information regarding the promotion at 1534. In at least one embodiment, the information provided may include a banner image 1536 and an additional image or copy 1538. In the embodiment shown, the user may select to opt in at 1540 to offer the promotion at its venue.

Events feature 1504 may in some embodiments allow the authorized user to view published events 1541 (as shown in FIG. 15C), to view draft events 1542 (as shown in FIG. 15D), or to create new events 1544 at the venue. When viewing published or draft events, the events may be displayed in a list form as shown at 1546. Each list may display the date 1547 and description 1548 of the event. Each list may also provide the authorized user with action items, such as to publish or unpublish 1550, edit 1552, or delete 1554 the event. To create a new event 1544, as shown in FIGS. 15E-15F, an authorized user enters an event title 1556, an event description 1558, a start date and time 1560, an end date and time 1562, and selects either that the event is a one-time event 1564 as shown in FIG. 15E or a recurring event 1566 as shown in FIG. 15F. If the event is a recurring event, the authorized user selects the recurrence parameters 1568 and an end date 1570 for the recurrence. In at least one embodiment, a calendar feature 1571 is utilized to help an authorized user select the dates. The authorized user then saves the new event as a draft by selecting the save feature 1572 or publishes the new event by selecting the publish feature 1573. FIG. 15G shows an embodiment where a user is editing a prior published or drafted event. Here, the authorized user can modify the event title 1556, the event description 1558, the start date and time 1560, the end date and time 1562, and whether the event is a one-time event 1564 or a recurring event 1568. The authorized user then saves the new event as a draft by selecting the save feature 1572 or publishes the new event by selecting the publish feature 1573.

FIG. 15H shows an embodiment of the data analytics feature 1506, which allows an authorized user to review analytics reports, which may be regularly occurring reports or custom-created. In at least one embodiment, the reports are displayed in a list form as shown at 1580. The authorized user may be provided with several action items, shown generally at 1582 related to the list, such as to view the report), to delete the report, to download the report, or to share the report.

FIG. 15I shows an embodiment of the management feature 1508. Here, the authorized user may edit any of the parameters entered for the particular venue on the venue sign in page, including the bar name 1584, address 1585, phone number 1586, website 1587, a description of the venue 1588, photos 1589, e-mail contact information 1590, hours 1591, e-mail preferences 1592, activities 1594, and venue type 1596. The user can then save the changes by selecting the “publish” button 1598, or can abort the changes by selecting the cancel button 1599.

FIGS. 16A-16Q show a vendor interface 1600 that communicates with the MCP 140. The authorized user for the vendor may select various features on the venue interface 1600, including to view (or create) vendor promotions 1602, notifications 1604, data analytics 1606, or loyalty rewards 1608 associated with the vendor The authorized user may also manage the vendor account through the management feature at 1609 and may also securely log out from the system through the logout feature at 1610. In some embodiments, such as those shown in these Figures, the promotions feature 1602, notifications feature 1604, data analytics 1606, loyalty rewards feature 1608, management feature 1609 and logout feature 1610 are always visible on vendor interface 1600. FIG. 16A shows the vendor interface 1600 with the promotions feature 1602 selected. Promotions feature 1602 may in some embodiments allow the authorized user to view active promotions 1612, as shown in FIG. 16A; to view upcoming promotions 1614, as shown in FIG. 16B; and to view inactive promotions 1616, as shown in FIG. 16C. In each instance, a list of relevant promotions 1622, 1624, 1626 is displayed. Each list may display the offer information and the duration. Each list may also provide the authorized user with an action item, as shown at 1630 in FIG. 16C, such as to activate the promotion, reactivate, edit, delete, or select the status of the promotion.

FIGS. 16D-16E relate to creating new promotions, either not targeted promotions as shown in FIG. 16D or targeted promotions as shown in FIG. 16E. The authorized user may create a new promotion by selecting the new promotion feature 1650. In at least the embodiment shown, the authorized user enters a product name 1656, a promotion description 1658, a start date and/or time 1660, and an end date and/or time 1662. The authorized user may upload one, two, or more photos 1664, such as a banner image or another digital image. In at least the embodiment shown, the authorized user selects a city where the promotion can be redeemed (shown generally at 1666) and respective venues in that city where the vendor will allow the promotion to be redeemed (shown generally at 1668). In at least one embodiment, once the promotion is published, the venue may have the opportunity to accept or decline redemption of the promotion. The authorized user may then select whether the promotion is a targeted event to be sent and/or redeemed only by a particular demographic or by all demographics, as shown generally at 1670. If the event is a targeted event, as the authorized user selects the targeting parameters 1672, such as gender, sexual orientation, designated age groups, relationship status. In at least one embodiment, the authorized user may also select to include a loyalty reward, as shown generally at 1673. The authorized user then saves the new promotion as a draft by selecting the save feature 1674 or publishes the new event by selecting the publish feature 1675. In some embodiments, the authorized user cannot edit a prior published promotion. In some embodiments, the authorized user cannot delete a prior published promotion once a venue has opted to accept it. FIG. 16F shows an embodiment where an authorized user is editing a prior drafted promotion. Here, the authorized user can modify the promotion information such as the product name 1656, the promotion description 1658, the start date and/or time 1660, the end date and/or time 1662, photos 1664, selected cities for the venue (shown generally at 1666), invited venues for the promotion (shown generally at 1668), whether the promotion is a targeted event (shown generally at 1670), targeting parameters 1672, and whether a loyalty reward is associated with the promotion. The authorized user then can save the edited promotion as a draft by selecting the save feature 1674 or publishes the new event by selecting the publish feature 1675. In at least one embodiment, when the authorized user has selected the publish feature 1675, a confirmation screen 1676 appears, which allows the authorized user to review the promotion before it is sent to venues and/or individual users. Once allowed, the promotion is stored in the MCP 140 for distribution to venues and/or individual users based on their respective profiles and/or User Fit Engine 180.

In at least one embodiment, as shown in FIG. 16H, the vendor can view a promotion detail 1676, including information such as the product name 1656, the promotion description 1658, the related photos 1664, the selected cities 1666, the target audience based on targeting parameters 1672, whether there is a loyalty reward associated with the program 1673, and a list 1677 of invited venues who have either accepted the promotion, denied the promotion, or where the promotion is still pending for review by the venue. The list 1677 may be sorted based on whether the promotion was accepted, denied, or still pending as shown generally at 1678. The vendor also has the option to take action regarding the venue, such as contacting the venue, as shown generally at 1679.

As shown in FIGS. 16I-16J, the vendor can view notifications received from the MCP 140 by selecting the notifications feature 1604, for instance notifications regarding venues opting into (i.e. accepting) or opting out of (i.e. denying) a promotion. The vendor can select whether to view venues opting into or opting out of the promotion with selection feature 1681, and the information is displayed as a list as shown generally at 1680. The information may include the promotion, the venue name, and the date upon which the venue either opted into or opted out of the promotion.

In at least one embodiment, as shown in FIGS. 16K-16N, the authorized user can create new loyalty reward coupons, edit coupons and review active or inactive coupons stored in MCP 140. In at least the embodiment of the loyalty coupon screen 1682 shown in FIG. 16K, the authorized user can create a new coupon, or edit an existing coupon as shown in FIG. 16L, by entering or editing information included but not limited to the coupon title, expiration date, the coupon details, and the maximum number of user redemptions allowed. In at least one embodiment, the authorized user can select using the loyalty reward list selector 1683 to display a list 1684 or either active rewards and/or inactive rewards. The authorized user may click on each loyalty reward in the list to display information about the reward, edit the reward or delete the reward.

FIGS. 16O-16Q show the data analytics feature 1606, which allows an authorized user to review analytics reports, which may be regularly occurring reports or custom-created. In at least one embodiment, the reports are displayed in a list form as shown at 1685. The authorized user may be provided with several action items, shown generally at 1686 related to the list, such as to view the report (as shown in FIG. 16Q), to delete the report, to download the report, or to share the report. In at least one embodiment, as shown in FIG. 16P, the authorized user may specify custom report criteria 1687. In at least one embodiment, the analytics report may be viewed directly within vendor interface 1600 as shown in FIG. 16Q. Data available to vendors from analytics reports may include, but is not limited to, demographic information for users receiving promotions (e.g. age, gender, location, relationship status, sexual orientation or preference, profession, music preferences, drink preferences), viewing promotions (e.g. age, gender, location, relationship status, sexual orientation or preference, profession, music preferences, drink preferences), and/or redeeming promotions (e.g. age, gender, location; relationship status, sexual orientation or preference, profession, music preferences, drink preferences). In addition, and particularly for targeted promotions, the data may also include views on a user's home screen, average screen swipes until the promotion is viewed, average moves away from the promotion, number of views, where the promotion is viewed on the user's home screen, number of actual redemptions, number of potential redemptions, number of saves, number of favorites, number of deletions from saves or favorites, average number of clicks or taps before a user receives the promotion, frequency of redemption of same promotion by a single user, proximity of user location to the promotion, venues where the promotion has been redeemed, information regarding loyalty rewards such as the number of reward notifications sent to users and/or the number of reward notifications viewed, deleted, or ignored. In at least one embodiment, data may be viewed by a variety of demographic parameters, including but not limited to city, user gender, user age, venue type and/or venue activities.

FIGS. 16R-16T shows the management feature 1609. Here, the authorized user may edit any of the parameters initially entered for the particular vendor on the vendor sign in page, including vendor name 1688, contact name 1689, contact e-mail 1690, and phone number 1691. The authorized user may also edit the password at 1692. At least for searching or indexing purposes, the vendor may also select its good or services type, for instance, it may select a particular type of alcohol that it sells (beer, wine, vodka, whiskey, etc.) as shown generally at 1693. The user can then save the changes by selecting the “save” button 1698.

FIGS. 17A-17S show an embodiment 1700 of the vendor interface 1600 shown in FIGS. 16A-16T. The authorized user for the vendor may select various features on the venue interface 1700, including to view (or create) vendor promotions 1702, notifications 1704, data analytics 1706, or loyalty rewards 1708 associated with the vendor. The authorized user may also manage the vendor account through the management feature at 1709 and may also securely log out from the system through the logout feature at 1710. FIG. 17A shows the vendor interface 1700 with the promotions feature 1702 selected. The authorized user may view active promotions 1712, as shown in FIG. 17A; and/or view inactive promotions 1714, as shown in FIG. 17B. In each instance, a list of relevant promotions 1716, 1718 is displayed. Each list may display the offer information 1715, the duration 1717, and the status 1719. Each list may also provide the authorized user with an action item, as shown at 1730 in FIG. 17B, such as to activate the promotion, reactivate, edit, delete, or select the status of the promotion.

The authorized user may create a new promotion by selecting the new promotion feature 1750. FIGS. 17C-17O relate to creating new promotions, either not targeted promotions as shown in FIG. 17C or targeted promotions as shown in FIG. 17D. In at least the embodiment shown, the authorized user enters a product or promotion name 1756, a promotion description 1758, a start date and/or time 1760, and an end date and/or time 1762. The authorized user may upload one, two, or more photos 1764, such as a banner image or another digital image. In at least the embodiment shown, the authorized user selects a city where the promotion can be redeemed (shown generally at 1766) and respective venues in that city where the vendor will allow the promotion to be redeemed (shown generally at 1768). In at least one embodiment, once the promotion is published, the venue may have the opportunity to accept or decline redemption of the promotion. The authorized user may then select whether the promotion is a targeted event to be sent and/or redeemed only by a particular demographic or by all demographics, as shown generally at 1770. If the event is a targeted event, the authorized user selects the targeting parameters 1772, such as gender, sexual orientation and/or preference, designated age groups, relationship status. In at least one embodiment, the authorized user may also select to include a loyalty reward, as shown generally at 1773. The authorized user then saves the new promotion as a draft by selecting the save feature 1774 or publishes the new event by selecting the publish feature 1775. In some embodiments, the authorized user cannot edit a prior published promotion. In some embodiments, the authorized user cannot delete a prior published promotion once a venue has opted to accept it. FIG. 17E shows an embodiment where an authorized user is editing a prior drafted promotion. Here, the authorized user can modify the promotion information such as the product name 1756, the promotion description 1758, the start date and/or time 1760, the end date and/or time 1762, photos 1764, selected cities for the venue (shown generally at 1766), invited venues for the promotion (shown generally at 1768), whether the promotion is a targeted event (shown generally at 1770), targeting parameters 1772, and/or whether a loyalty reward is associated with the promotion (shown generally at 1773). The authorized user then saves the edited promotion as a draft by selecting the save feature 1774 or publishes the new event by selecting the publish feature 1775. In at least one embodiment, when the authorized user has selected the publish feature 1775, a confirmation screen 1771 appears as shown on FIG. 17F, which allows the authorized user to review the promotion and promotion information 1756, 1758, 1760, 1762, 1764, 1766, 1772, 1773 before it is sent to venues and/or individual users. Once allowed, the promotion is stored in the MCP 140 for distribution to venues and/or individual users based on their respective profiles and/or User Fit Engine 180.

In at least one embodiment, as shown in FIG. 17G, the vendor can view a promotion detail 1776, including information such as the product name 1756, the promotion description 1758, the related photos 1764, the selected cities 1766, the target audience based on targeting parameters 1772, whether there is a loyalty reward associated with the program 1773, and/or a list 1777 of invited venues who have either accepted the promotion, denied the promotion, or where the promotion is still pending for review by the venue. The list 1777 may be sorted based on whether the promotion was viewed, accepted, denied, or still pending as shown generally at 1778. The vendor also has the option to take action regarding the venue, such as contacting the venue, as shown generally at 1779.

FIGS. 17H-17I, the vendor can view notifications received from the MCP 140 by selecting the notifications feature 1704, for instance notifications regarding venues opting into (i.e. accepting) or opting out of (i.e. denying) a promotion. The vendor can select whether to view venues opting into or opting out of the promotion with selection feature 1781, and the information is displayed as a list as shown generally at 1780. The information may include the promotion, the venue name, and the date upon which the venue either opted into or opted out of the promotion.

As shown in FIGS. 17J-17K, through the loyalty rewards feature 1708, the authorized user may view a list 1782 of loyalty reward coupons that are active (as shown in FIG. 17J) or inactive (as shown in FIG. 17K). In at least one embodiment, the authorized user may view the coupon name 1783, the associated promotion 1784, and the total number of coupons redeemed 1785. In some embodiments, the authorized user may select an action 1786, such as to deactivate an active award, to edit the reward, or to delete the award. The authorized user may click on each loyalty reward in the list to display information about the reward, edit the reward or delete the reward.

FIGS. 17L-17Q show the data analytics feature 1706, which allows an authorized user to review analytics reports, which may be regularly occurring reports or custom-created. In at least one embodiment, the reports are displayed in a list form as shown at 1787. The authorized user may be provided with several action items, shown generally at 1788 related to the list, such as to view the report 1789 (as shown in FIG. 17N-17Q), to delete the report, to download the report, or to share the report. In at least one embodiment, as shown in FIG. 17M, the authorized user may specify custom report criteria 1790 and submit their request at 1791.

FIGS. 17R-17S shows the management feature 1709. Here, the authorized user may edit any of the parameters initially entered for the particular vendor on the vendor sign in page, including vendor or brand name 1792, contact name 1793, contact e-mail 1794, and phone number 1795. The authorized user may also edit the password at 1796. At least for searching or indexing purposes, the vendor may also select its goods or services type, for instance, it may select a particular type of alcohol that it sells (beer, wine, vodka, whiskey, etc.) as shown generally at 1797. The user can then save the changes by selecting the “save” button 1798, or the “cancel” button 1799 to remove the changes. In at least one embodiment, the authorized user may also request renewal of its subscription with System 100.

FIGS. 18A-18C show a modification of the vendor interface 1600, 1700 described above with respect to FIGS. 16-17. Here, the vendor has identified as part of its profile that it has more than one brand that it seeks to promote (referred to herein as a “super vendor”). The authorized user for the super vendor may select various features on the venue interface 1800, including to view (or create) vendor promotions 1802, notifications 1804, data analytics 1806, or loyalty rewards 1808 associated with the vendor. The authorized user may also manage the “super vendor” account through the management feature at 1809, which may include adding brands to the vendor profile, and the authorized user may also securely log out from the system through the logout feature at 1810. FIG. 18A shows the vendor interface 1800 with the promotions feature 1802 selected. Promotions feature 1802 may in some embodiments allow the authorized user to view active promotions for a first brand 1812a and a second brand 1812b, as shown in FIG. 18A; to view upcoming promotions for a first brand 1814a and a second brand 1814b, as shown in FIG. 18B; and to view inactive promotions 1816a and a second brand 1816b, as shown in FIG. 18C. The authorized user may use a brand selector feature (such as dropdown menu 1820) to select one or more brands for viewing. In each instance, a list of relevant promotions for each brand 1822a, 1822b, 1824a, 1824b, 1826a, 1826b is displayed. Each list may display the offer information and the duration. Each list may also provide the authorized user with an action item, as shown at 1830 in FIG. 18C, such as to activate the promotion, reactivate, edit, delete, or select the status of the promotion. With regards to analytics reports, the various analytic data may be sorted and analyzed by brand or for the vendor as a whole.

FIGS. 19A-19O show an administrator interface 1900 that communicates with the MCP 140. The administrator may select various features on the administrator interface 1900, which may include features to view vendors 1902, to view venues 1904, and to access data analytics 1906. The administrator may also securely log out from the system through the logout feature at 1910. In some embodiments, such as those shown in these Figures, the vendors feature 1902, venues feature 1904, data analytics 1906 and logout feature 1910 are always visible on administrator interface 1900. FIG. 19A shows the vendor interface 1900 with the vendors feature 1902 selected. Vendors feature 1902 may in some embodiments allow the administrator to view new vendor requests 1912 (such as subscription renewals, new accounts, or custom analytics reports), as shown in FIG. 19A; to view active vendors 1914, as shown in FIG. 19B; and to view inactive or expired vendors 1916, as shown in FIG. 19C. In each instance, a list of relevant vendors 1922, 1924, 1926 is displayed. Each list may display vendor information such as the vendor name 1928, vendor status 1929, and subscription expiration date 1930. Each list may also provide the authorized user with an action item, as shown at 1932 in FIGS. 19A-19C, such as to view the vendor profile, contact the vendor, approve the vendor's request, reject the vendor's request, renew a subscription, run a report, or delete a vendor from the list.

FIGS. 19D-19F relate to reviewing a vendor's request for a new account, or to edit their account. The administrator may review a new account by selecting action item 1932 for review on one of the vendors listed in list 1922, as shown in FIG. 19A. In at least the embodiment shown in FIGS. 19D-19F, the administrator can view and/or edit the vendor contact information (shown generally at 1942), brand name 1944, a drink type 1946, the password 1948, and/or the expiration date 1950 of the vendor account. The administrator can then select either the reject feature 1952 or the approve feature 1954 depending on whether the administrator wishes to approve or reject the new vendor or edits made to the new vendor's information. Once allowed, the administrator interface communicates with the MCP 140 to update the vendor interface and other vendor-related information in the MCP 140.

FIGS. 19G-19I relate to reviewing a vendor's analytics report. The administrator may review a report by selecting action item 1932 for reviewing reports, which may be regularly occurring reports or custom-created. In at least one embodiment, the reports are displayed in a list form as shown at 1955. The authorized user may be provided with several action items, shown generally at 1956 related to the list, such as to view the report (as shown in FIG. 19I), to delete the report, to download the report, or to share the report. In at least one embodiment, as shown in FIG. 19H, the administrator may run a custom report 1957 based on specified criteria. In at least one embodiment, the analytics report 1958 may be viewed directly within administrator interface 1900 as shown in FIG. 19I or may be sent to the vendor.

FIGS. 19J-19O show the administrator interface 1900 with the venues feature 1904 selected. Venues feature 1904 may in some embodiments allow the administrator to view pending venues 1961, as shown in FIG. 19J; and to view active venues 1962, as shown in FIG. 19K. In each instance, a list of relevant venues 1963, 1964 is displayed. Each list may display venue information such as the venue name 1965 and venue location 1966. Each list may also provide the authorized user with an action item, as shown at 1967 in FIGS. 19A-19C, such as to activate to view the venue profile, contact the venue, approve the venue's request, reject the venue's request, renew a subscription, run a report, or delete a venue from the list.

FIGS. 19L-19M relate to reviewing a venue's request for a new account, or to edit their account. FIG. 19L shows review of a new venue request, and FIG. 19M shows editing a venue's account. The administrator may review a new account by selecting action item 1967 for review on one of the venues listed in list 1963, 1964. In at least the embodiment shown in FIGS. 19L-19M, the administrator can view and/or edit the venue name 1968, address 1969, description 1970, photo 1971, contact information 1972, hours 1973, venue type 1974 and activities 1975. The administrator can then select either the reject feature 1976 or the approve feature 1978 depending on whether the administrator wishes to approve or reject the new venue or edits made to the new venue's information. Once allowed, the administrator interface communicates with the MCP 140 to update the venue interface and other venue-related information in the MCP 140.

FIGS. 19N-19O relate to reviewing a venue's analytics report. The administrator may review a report by selecting action item 1967 for reviewing reports, which may be regularly occurring reports or custom-created. In at least one embodiment, the reports are displayed in a list form as shown at 1969. The authorized user may be provided with several action items, shown generally at 1970 related to the list, such as to view the report, to delete the report, to download the report, or to share the report. In at least one embodiment shown in FIG. 19O, the analytics report 1972 may be viewed directly within administrator interface 1900 or may be sent to the venue.

FIGS. 20A-20L show an embodiment 2000 of the administrator interface 2000 shown in FIGS. 19A-19O. The administrator may select various features on the administrator interface 2000, which may include features to view vendors 2002, to view venues 2004, and to access data analytics 2006 for the whole system. The administrator may also securely log out from the system through the logout feature at 2010. In some embodiments, such as those shown in these Figures, the vendors feature 2002, venues feature 2004, data analytics 2006 and logout feature 2010 are always visible on administrator interface 2000. FIG. 20A shows the vendor interface 2000 with the vendors feature 2002 selected. Vendors feature 2002 may in some embodiments allow the administrator to view new vendor requests 2012 (such as subscription renewals, new accounts, or custom analytics reports), as shown in FIG. 20A; to view active vendors 2014, as shown in FIG. 20B; and to view inactive or expired vendors 2016, as shown in FIG. 20C. In each instance, a list of relevant vendors 2022, 2024, 2026 is displayed. Each list may display vendor information such as the vendor name 2028, vendor status 2029, and/or subscription expiration date. Each list may also provide the authorized user with an action item, as shown at 2032 in FIGS. 20A-20C, such as to activate to view the vendor profile, contact the vendor, approve the vendor's request, reject the vendor's request, renew a subscription, run a report, or delete a vendor from the list.

FIGS. 20D-20E relate to reviewing a vendor's request for a new account, or to edit their account. The administrator may review a new account by selecting “edit” action item shown generally at 2032 for review on one of the vendors listed in list 2022, as shown in FIG. 20A. In at least the embodiment shown in FIGS. 20D-20E, the administrator can view and/or edit the vendor contact information shown generally at 2042, brand name 2044, a drink type 2046, the password 2048, and the expiration date 2050 of the vendor account. The administrator can then select either the reject (or delete) feature 2052 or the approve (or update) feature 2054 depending on whether the administrator wishes to approve or reject the new vendor or edits made to the new vendor's information. Once allowed, the administrator interface communicates with the MCP 140 to update the vendor interface and other vendor-related information in the MCP 140.

FIGS. 20E-20G relate to reviewing a vendor's analytics report. The administrator may review a report by selecting “reports” action item 2032. The reports may be regularly occurring reports or custom-created. In at least one embodiment, the reports are displayed in a list form as shown at 2055. In at least one embodiment, the list can be sorted by regularly occurring or custom reports or by date. The authorized user may be provided with several action items, shown generally at 2056 related to the list, such as to view the report, to delete the report, to download the report, or to share (“send”) the report. In at least one embodiment, as shown in FIG. 20G, the administrator may run a custom report 2057 based on specified criteria.

FIG. 20H-20L show the administrator interface 2000 with the venues feature 2004 selected. Venues feature 2004 may in some embodiments allow the administrator to view pending venues 2061, as shown in FIG. 20H and to view active venues 2062, as shown in FIG. 20I. In each instance, a list of relevant venues 2063, 2064 is displayed. Each list may display venue information such as the venue name 2065 and venue location 2066. Each list may also provide the authorized user with an action item, as shown at 2067, to view the venue profile, contact the venue, approve the venue's request, reject the venue's request, renew a subscription, run a report, or delete a venue from the list.

FIGS. 20J-20K relate to reviewing a venue's request for a new account, or to edit their account. FIG. 20J shows review of a new venue request, and FIG. 20K shows editing a venue's account. The administrator may review a new account by selecting action item 2067 for review on one of the venues listed in list 2063, 2064. In at least the embodiment shown in FIGS. 20J-20K, the administrator can view and/or edit the venue name 2068, address 2069, description 2070, photo 2071, website, contact information 2072, hours 2073, venue type 2074 and activities 2075. The administrator can then select either the reject feature 2076 or the approve feature 2078 depending on whether the administrator wishes to approve or reject the new venue or edits made to the new venue's information. Once allowed, the administrator interface communicates with the MCP 140 to update the venue interface and other venue-related information in the MCP 140.

FIG. 20L relates to reviewing a venue's analytics report. The administrator may review a report by selecting the “reports” action item 2067. In at least one embodiment, the reports are displayed in a list form as shown at 2069, which may be sorted by date. The authorized user may be provided with several action items, shown generally at 2070 related to the list, such as to view the report, to delete the report, to download the report, or to share the report.

As discussed above, System 100 allows for users to access the system via a user interface on a personal user device 120. An embodiment of a user interface 320 is shown generally in FIGS. 21-24.

FIG. 21A shows a method of logging into the user's account or creating a new account. In some embodiments, the user may log into an account using their own social media account on a third party network, for example Facebook and Twitter. In other embodiments, a social media account is not required for login to create a profile. Where needed however, the social media account includes data such as the user's name, location, birth date, and/or a photo and exports that data to the System 100 to set up the user's profile. Importantly, where the system features liquor promotions, the System 100 will only allow the user to create an account based on the data retrieved from the third party network if the user is over the legal drinking age in their location, for example, twenty-one years of age in the United States. The user interface 2100 features a login screen 2102; a merge account screen 2104 that allows an existing user to update their data to use data from their social media account on a third party network; sign up screens 2106, 2108, 2109, 2110; an invite friends screen 2112; a reward screen 2114; an invite confirmation screen 2116; and/or a user home screen 2120. On the login screen 2102, the user has the option of selecting to log in with their social media account on the third party network (as shown at 2124 on FIG. 21B) or merging their existing user account with data obtained from their social media account on the third party network (as shown at 2126 on FIG. 21B). Where a user has an existing account on System 100 that already uses a social media account, selecting to log in at 2124 will validate the user account, log them into the system, and bring the user to the user home screen 2120. Where a user does not have an existing account on System 100, selecting to log in at 2124 will bring the user to the first sign up screen 2106 to initiate the profile creation process. In some embodiments where the user has an existing account but it is not connected to a social media account on a third party system, the user may be required to merge the existing account with the social media account by selecting to log in at 2126. The user is then brought to the merge account screen 2104 shown in FIG. 21C, where the user enters their user name or email address 2128 and password 2130 for their existing account. Once the user selects the login feature 2132, the user is taken to the third party network to authorize and link their social media account on the third party network to their existing account on system 100. After the account is linked to their social media account, the user is brought to the first sign up screen 2106. As shown in FIG. 21D, sign up screen 2106 asks a user to enter a first name at 2134, an email address at 2136, gender information at 2138, and/or birth date at 2140. Sign up screen 2106 also asks a user to select one or more photos of themselves at 2142. In at least one embodiment, the entries for the first name 2134, the email address 2136, the gender information 2138, the birth date 2140, and at least one photo 2142 will automatically populate from data retrieved from the third party network. In at least one embodiment, the user must select the “first pic” button 2144 to indicate which photo will appear first on the user's profile. In at least one embodiment, the user can override this automatically populated information. The birth date 2140 entered must of course indicate that the user is of an appropriate age in order to access some of the vendor promotions. In at least one embodiment, the user can import photos from the personal device's photo library or a photo album on the social media account stored on a third party network. In at least one embodiment, the user can also import videos. The user may then be brought to the second sign up screen 2108 (shown in FIG. 21E), where the user may answer one or more questions about themselves, such as who is their celebrity look-alike or three qualities about themselves. Depending on the question, the user may select from images 2146, or enter or select text 2148 to answer the question. In some embodiments, the answers may be auto-populated responses, which the user can change. The user may then be brought to the third sign up screen 2109, where the user may select what type of drink he or she likes or dislikes, as shown at 2150. Depending on the user's selections here, certain vendor promotions may or may not be sent to the user. In at least one embodiment, if the user dislikes a particular liquor, like scotch or vodka, any promotions relating to scotch will appear at the bottom of the promotions list at a venue or at nearby venues for that user. Once the user has made all required selections in the sign-up screen, the “done” button 2152 is activated. The user selects the “done” button and reviews his or her profile, at screen 2110 and selects the “next” button 2154. In some embodiments, the user is then taken to a screen 2112 to invite other friends or contacts to set up an account on the system 100, as shown in FIG. 21F. The user may invite friends through the third party network as shown at 2156 or contacts from their personal device as shown at 2158, or the user may bypass inviting friends by selecting not to invite friends as shown at 2160 and go directly to the home screen 2120. In at least one embodiment, the user may receive a reward for inviting friends as shown at screen 2114. In at least one embodiment, the user may receive confirmation on screen 2116 after friends have been successfully invited. As shown in FIG. 21G, the user may then select a “next” button 2162 and the user is then brought to the user home screen 2120.

FIGS. 22A-22P show various features of an embodiment of user home screen 2120. In at least the embodiment shown, the user home screen 2120 has an application navigation feature 2202, a visibility feature 2204 (or “sunglasses feature” as discussed above), a notifications feature 2206, and/or recommendation features 2208, 2210, 2212 populated by the User Fit Engine 180 and the MCP 140 based on location and other data stored in the profile database 310 for the user. In at least one embodiment, recommendation features may include venue recommendations 2208, promotion recommendations 2210 from a venue or vendor, and musing recommendations 2212. The recommendation features may include photo images, video, audio or text. In some embodiments, the venue recommendation features 2208 may include a photo, information about the distance from the user to the venue, whether the user has previously checked in, number of system users checked into the venue, number of potential muses at the venue, number of deals available at the venue, and/or number of events in the venue. Selecting the venue recommendation feature 2208 may open the venue's profile for the user to review. In at least one embodiment, the user may “check in” to the venue, as shown at 2214. In some embodiments the “check in” feature 2214 will only appear when the user is within a determined distance from the bar. In at least one embodiment, by selecting the “check in” feature, the venue where the user is currently checked in will appear on the user's profile 2110 for viewing by other users and/or displayed in the navigation feature 2202 as will be discussed further below. In some embodiments, promotion recommendations 2210 may include a photo or ad, the promotion title, and the time the promotion ends. In at least one embodiment, a timer will show for the duration of the promotion while the promotion remains active. If the promotion is not yet active, the time frame will display information about when the promotion will become active. In at least one embodiment, promotions are only visible on the day that they may be redeemed. Selecting the promotion recommendation 2210 may open the promotion for the user to review additional information. In some embodiments, the musing recommendations 2212 may show the muse's photo and the musing compatibility with the user and the muse. Selecting the musing recommendation 2212 may open the muse's profile for the user to review. In at least one embodiment, the user can scroll through the recommendations as shown in FIGS. 22A-22B. Recommendations may be sorted by the user's location (such that recommendations that are in closest proximity to the user are shown first) or by compatibility with other data stored in the profile database 310 for the user.

User home screen 2120 may further include a content filter 2216 and/or a sorting feature 2218. In at least one embodiment, selecting the content filter 2216 allows the user to “check” and “uncheck” whether muses, promotions, venues, friends, and/or events are displayed on the user home screen 2120, as shown in FIG. 22C. In at least one embodiment, the sorting feature 2218 allows the user to determine the order in which the recommendations 2208, 2210, 2212 are viewed. As shown in FIG. 22D, the sorting feature 2218 allows a user to view recommendations 2208, 2210, 2212 based on location, compatibility with other data stored in the profile database 210 for the user, or alphabetically. In at least one embodiment, compatibility for muses is based on responses to “get to know me” questions and/or number of mutual friends in the third party social network. In at least one embodiment, compatibility for venues is based on the number of check-ins by compatible muses; number of active deals on liked drink, food or other options; and/or number of liked activities available. Promotion recommendations are organized by compatibility at the venue at which the promotion is offered. The user may also access the heat map 2220 via the user home screen 2120, which is shown in FIG. 22E. Heat map 2220 shows a relative ring or other visual aid indicating the total number of check-ins at a given location. In at least one embodiment, selecting a pin 2221 on the heat map 2220 will open a preview window 2222 with the venue name and other relevant information, such as the number of potential muse matches. Selecting the preview window 2222 will take the user to the venue profile.

FIGS. 22F-22G relate to the visibility feature 2204 (or “sunglasses feature”), which when selected takes the user to the visibility screen 2224. In at least one embodiment, a user can select either to be hidden (“shades on”) 2226 or to be visible (“shades off”) 2228. FIG. 22F shows the user in hidden mode (“shades on”), and FIG. 22G shows the user in visible mode (“shades off”). This selection can be done by tapping the screen, or sliding a toggle feature on the screen. When the user is hidden, other users cannot see the hidden user's name, photos, and/or username. In some embodiments, other users cannot send instant messages or chat with a hidden user. Instead, the other user may send the user a request to “reveal themselves.” Hidden users may also be unable to send messages when in hidden mode. When the user is visible, other users can see the user's full profile (including photos) and send the user messages. Visible users may also send messages when in visible mode. In at least one embodiment, text on the visibility screen 2224 depends on whether the user is in hidden mode or visible mode. In at least one embodiment, the visibility screen 2224 includes a preview 2230 of the user's profile, which changes depending on whether the user is in hidden mode or visible mode.

FIGS. 22H-22I relate to the notifications feature 2206. In at least one embodiment, the user may be notified on the user home screen 2120 that a notification has been received, as shown at 2231 on FIG. 22H. When the user selects the notifications feature 2206, the user is brought to the notifications screen 2226 shown in FIG. 22I, where a list of notifications 2232 is shown. These notifications may include an invite from another user to get a drink, a reveal request from another user if the user is currently hidden, a friend request from another user, relevant promotions from vendors and venues, or whether a user request was accepted by another user. Where the notification is received from another user, the user can view the other user's profile by selecting their photo 2236. Where the notification is received from a vendor or venue related to a promotion, the user can view additional information about the deal by selecting the deal at 2239. The user can respond to the invite request or the reveal request by selecting yes or no as shown at 2238, or may respond by sending the other user a message, if they are not hidden. The user may also see past messages. In at least one embodiment, the user may also access an instant messenger feature 2240, which may be accessible through the notifications screen 2226 or the user home screen 2120 (shown in FIG. 22J). In at least one embodiment, common instant messaging features may be used to communicate with other users. In at least one embodiment, users may only instant message with other users designated as “friends”; however, users may instant message if they both mutually agree to meet or “grab a drink” through the notifications feature. As shown in FIG. 22K, the user can scroll down in the notification list or feed 2232 to view prior notifications.

FIGS. 22L-22P show various features of navigation feature 2202. As shown in FIG. 22L, navigation feature 2202 may include one or more of the following features: a profile feature 2242; a location feature 2243; a favorites feature 2244; a reward feature 2245; a friends feature 2246; a check-in feature 2248; an account management feature 2249; an account settings feature 2250; and a logout feature 2251. User's profile 2110 can be accessed by selecting profile feature 2242. Location feature 2243 displays the venue name where the user is currently checked-in. If the user is not checked-in to a location, it displays the user's last check-in. The favorites feature 2244 allows the user to compile a list of the user's favorite venues, vendors, events and/or muses. The rewards feature 2245 feature allows a user to view the rewards available and rewards redeemed. The friends feature 2246, as shown in FIGS. 22M-220, may include a request feature 2252 where the user may accept another user's friend request 2253 as shown generally at 2254, ignore a user's friend request as shown generally at 2256, or in some embodiments deny a user's friend request. The friend request 2253 may include the current (or last) check-in of the other user, as shown generally at 2257. The user may click, tap, or otherwise select the friend request 2253 to view the user's profile. The friends feature 2246 may further include a list feature 2260, as shown in FIG. 22N, which shows all of the user's friends like a “little black book.” Each friend listing 2261 may include the current (or last) check-in of the friend, as shown generally at 2263. The user may click, tap, or otherwise select the friend listing 2261 to view the friend's profile. The list feature 2260 may further include a search function 2264 for the user to find a particular friend listing 2261. The friend feature 2246 may further include a search feature 2262 for a user to find new friends, as shown in FIG. 22O. The search feature 2262 includes a search function 2265 for finding potential new friend listings or may auto-populate potential new friend listings 2666. The user can then send a friend request by selecting the “add” feature 2267. The user can also invite a friend through social media or text message via the “invite” feature 2268. The check-in feature 2248 may provide a check-in list feature 2269, as shown in FIG. 22P, which shows all of the user's check-ins 2270. Check-in 2270 may include the name of the venue and the date and/or time stamp for when the user checked-in. The user may click, tap, or otherwise select the check-in 2270 to view additional information about the check-in or venue.

FIG. 23A shows a method for editing the user's profile 2120 and/or user settings. On user home screen 2120, the user selects the navigation feature 2202 as shown in FIGS. 22L-22P. The user may select the profile feature 2242 to bring the user to the user's profile 2210, which is shown in FIG. 23B. The user's profile 2210 as shown in FIG. 23B includes an editing feature 2302 and a settings feature 2304. When the editing feature 2302 is selected, the user is taken to an editing screen 2310 shown in FIG. 23C. The user may edit one or more features of the user's profile, for instance the user's name 2312, the user's e-mail address 2312, the user's gender 2313, the user's birthdate 2314, the user's photos 2315, the user's celebrity look-alike 2316, and the type of people the user wishes to meet 2317 (as shown in FIG. 23D). In at least one embodiment, the user can select privacy restrictions or the visibility of each feature, as shown generally at 2320. In at least one embodiment, the user may provide answers to a “fun facts feature” 2318 as shown generally in FIGS. 23E-23F. The user may choose not to have an answer published or to have the answer unpublished by selecting “unpublished” feature 2319.

When the settings feature 2304 is selected, the user is taken to an editing screen 2330 shown in FIG. 23G, where the user can choose to view lists of blocked users (shown generally at 2331), blocked venues (shown generally at 2332), and blocked vendors (shown generally at 2333); update notification settings (shown generally at 2334); and update social settings (shown generally at 2335). As shown in FIG. 23H, the user can view a list 2240 of blocked users, venues, or vendors and choose to unblock a select user, venue, or vendor, as shown generally at 2342. As shown in FIG. 23I, the user can update notification settings on notification screen 2350, by selecting e-mail notifications 2352 or push notifications 2354 for a variety of activities, such as getting a message, receiving a friend request, a promotion from one of the user's favorite vendors, and/or a promotion or event at one of the user's favorite venues. In at least one embodiment, the user can also select to receive push notifications to check-in when it is in close proximity to a venue, as shown generally at 2356. As shown in FIG. 23J, the user can also select to receive push notifications for promotions when it is in close proximity to a venue, as shown generally at 2357; push notifications for muses when it is in close proximity to the muse, as shown generally at 2358; and select the desired compatibility percentage for a muse before a notification will be sent, as shown generally at 2359. FIG. 23K shows the various social settings 2360 that a user may select, including sharing check-ins on a third party social media network (shown generally at 2361); sharing unlocked specials on a third party social media network (shown generally at 2362); connecting or disconnecting from a third party social media network (shown at 2363).

FIGS. 24A-24H show examples of various methods and features for implementing the musing feature of the system and the rewards feature. FIG. 24A shows a method of implementing the muse feature of the system. Depending on the user's location and/or the user's inputed parameters of the user's profile 310 stored in the MCP 140 and the User Fit Engine 180, a plurality of muses 2212 may be visible on the user home screen 2120 at any given time. The user can select the muse to view the muse's profile 2420 shown in FIG. 24B. Alternatively, the user may select a venue 2208 that is visible on the user home screen 2120. The venue profile 2410 may include muse 2212, and the user can select the muse 2212 to view the muse's profile 2420. Venue profile 2410 may also include one or more of the following features: a return button 2411 to return the user to the previous screen; a favorite button 2412 to add the venue to the user's favorites; a share button 2413 to share information regarding the venue on social media, via text message, or via email; a blocking feature 2414; a reward progress bar 2416, which may trigger a reward based on the number of check-ins at the venue or other similar accomplishment; a venue-related promotion 2210; and a check-in feature 2418. The venue profile 2410 may also include events, additional details about the venue, hours, phone number, address, and/or website. Muse's profile 2420 may include one or more of the following features: a friend feature 2421 for the user to add the muse as a friend, if it is not already friends with the muse, or delete the muse as a friend once it is friends; a settings feature 2422 where the user can block a muse; at least one photo 2423 of the muse; a compatibility statistic 2424 based on the User Fit Engine 180 and the MCP 140; the muse's current location 2425 or the muse's last check-in location; and a messaging feature 2426. The messaging feature 2426 in some embodiments may have multiple states: if the muse's profile is hidden, the messaging feature 2426 may request that the user reveal himself or herself (change his or her visibility status); if the muse's profile is visible and the muse is checked into the same bar as the user, the messaging feature 2426 may allow the user to send a message to the muse and messaging screen 2240 from FIG. 22J is visible; if the muse and the user are friends, the messaging feature 2426 may also allow the user to send a message to the muse and messaging screen 2240 is visible. In some embodiments, a reward may be associated with communicating with a muse, as shown in FIG. 24C, and a reward screen 2430 is visible and the user may redeem the reward, as shown in FIG. 24D.

FIG. 24A also shows a method of viewing and redeeming rewards, which may be social rewards or sales rewards like for drink specials or restaurant specials, or other coupons. Depending on the user's location and/or the user's inputted parameters of the user's profile 310 stored in the MCP 140 and the User Fit Engine 180, a plurality of promotions 2210 may be visible on the user home screen 2120 at any given time. The user can select the promotion to view the muse's profile 2420 shown in FIG. 24B. Alternatively, the user may select a venue 2208 that is visible on the user home screen 2120 and view at least one promotion 2210 on venue profile 2410. Either way, by selecting the promotion 2210, the promotion profile 2450 is then visible, which is populated by information stored in the MCP 140 from the venue or vendor interfaces discussed above. Promotion profile 2450, as shown in FIG. 24E, may include one or more of the following features: a return button 2451 to return the user to the previous screen; a favorite button 2452 to add the promotion to the user's favorites; a share button 2453 to share information regarding the promotion on social media, via text message, or via email; a blocking feature 2455; information or an image regarding the deal 2454; the date/time or the remaining duration of the promotion 2456; a reward progress bar 2457, which may trigger a reward based on the number of redemptions of the promotion; a list of venues where the promotion is available 2458, which the user may click, tap or otherwise select in order to view vendor profile 2410; availability notification 2459, which provides notice as to any requirements for redemption of the promotion (for instance, to be checked-in to the venue). In some cases, a check-in feature may also be on the promotion profile 2450. In some embodiments, a reward may be associated with checking-in to a venue, and a reward screen 2460 as shown in FIG. 24H is visible. If the user meets all the requirements for the promotion, a “redeem now” 2470 feature appears on the promotion profile 2450, as shown in FIG. 24F. In at least one embodiment, the “redeem now” feature only appears if the user is checked-in to the venue. In some embodiments, where a reward is offered, a redemption window 2480 appears as shown in FIG. 24G, showing the rebate and providing instructions regarding redemption. In at least one embodiment, redemption window provides the option 2482 for the user to e-mail himself or herself with the reward.

Alternative visual embodiments of the user interface of the present disclosure, including how embodiments of the present disclosure may appear in an Apple environment or a Droid environment, are included in the provisional application to which this application claims priority, App. Ser. No. 61/792,097, and this application is incorporated by reference in its entirety.

While the products, systems, and methods have been described in reference to some exemplary embodiments, these embodiments are not limiting and are not necessarily exclusive of each other, and it is contemplated that particular features of various embodiments may be omitted or combined for use with features of other embodiments while remaining within the scope of the invention.

What is claimed is:

1. A system for engaging with a mobile community, the system comprising:
a mobile device configured to send and receive communication;
a mobile community provider communicatively coupled to the mobile device via a network, wherein the mobile community provider comprises a user activity analyzer engine and a relationship analyzer engine.

2. The system of claim 1, wherein the mobile community provider further comprises a profile interface.

3. The system of claim 2, wherein the profile interface is a vendor interface.

4. The system of claim 2, wherein the profile interface is a venue interface.

5. The system of claim 2, wherein the profile interface is an administrator interface.

6. The system of claim 2, wherein the profile interface is a user interface.

7. The system of claim 1, wherein the mobile community provider further comprises a heat map module.

8. The system of claim 7, wherein the heat map module uses GPS mapping to identify trending locations based on volume of guests and activity.

8. The system of claim 1, wherein the mobile community provider further comprises a musing module to determine a match between users.

9. The system of claim 1, wherein the mobile community provider further comprises an intel module.

10. The system of claim 1, wherein the mobile community provider further comprises a scan artist module.

11. The system of claim 1, wherein the scan artist module is in communication with a camera feature of a smartphone.

12. The system of claim 1, wherein the mobile community provider sends targeted promotions from a vendor to a user.

13. The system of claim 1, wherein the mobile community provider sends to a user targeted vendor promotions at a venue in close geographic proximity to the user.

14. The system of claim 1, wherein the mobile community provider matches users based on analysis by at least one of the user activity analyzer engine and the relationship analyzer engine.

15. The system of claim 1, wherein the mobile community provider provides data analytics to a vendor through a vendor interface.

16. The system of claim 1, wherein the mobile community provider provides data analytics to a vendor through a venue interface.

17. The system of claim 1, further comprising a profile database.

18. The system of claim 1, wherein the mobile community provider further comprises a sunglasses feature.

19. A method for engaging a first user having a mobile device with a second user at a known location in close proximity to the first user, the method comprising:
communicating with a mobile community provider coupled to the mobile device via a network, wherein the mobile community provider comprises a user activity analyzer engine and a relationship analyzer engine.
determining a matching score of the first user and the second user based on an analysis of profile information of the first user and profile information of the second user;
updating the user home screen of the first user with a muse for the second user when the matching score is above a predetermined score.

20. A method for engaging a user having a mobile device with a promotion by a preferred vendor, the method comprising:
communicating with a mobile community provider coupled to the mobile device via a network, wherein the mobile community provider comprises a user activity analyzer engine and a relationship analyzer engine, wherein the mobile community provider has information regarding the user's preferred vendor
updating the user home screen of the first user with a promotion by the preferred vendor.
